(19) United States
(12) Patent Application Publication
(10) Pub. No.: US 2025/0069872 A1
(43) Pub. Date: Feb. 27, 2025

(54) METHOD FOR CALIBRATING MASS DISCRIMINATION EFFECT OF NEON ISOTOPE RATIO

(71) Applicant: Institute of Geology and Geophysics, Chinese Academy of Sciences, Beijing (CN)

(72) Inventors: Xuhang ZHANG, Beijing (CN); Fei SU, Beijing (CN); Huaiyu HE, Beijing (CN)

(21) Appl. No.: 18/677,912

(22) Filed: May 30, 2024

(30) Foreign Application Priority Data
Aug. 23, 2023 (CN) 202311069829.2

(51) Int. Cl. H01J 49/00

(52) U.S. Cl. CPC H01J 49/0009; H01J 49/0036

(57) ABSTRACT

The disclosure discloses a method for calibrating a mass discrimination effect of a neon isotope ratio, belonging to a field of isotope measurement. The following steps are provided: providing N kinds of standard gases with different gas semaphores, and respectively testing ²⁰Ne and ²²Ne in the N kinds of standard gases (air) by using a mass spectrometer to obtain N data sets; obtaining a functional equation (²⁰Ne/²²Ne)ₐᵢᵣ=²⁰Ne/²²Ne=A(²²Ne)+B from the N data sets by a mathematical fitting method; providing a test sample, and testing ²⁰Neₛₐₘₚₗₑ and ²²Neₛₐₘₚₗₑ in the sample by a mass spectrometer; making ²²Ne equal to ²²Neₛₐₘₚₗₑ, obtaining a functional equation (²⁰Ne/²²Ne)ₐᵢᵣ₍ₛₐₘₚₗₑ₎=A(²²Neₛₐₘₚₗₑ)+B; obtaining a mass discrimination factor according to D=(²⁰Ne/²²Ne)ₐᵢᵣ₍ₛₐₘₚₗₑ₎/(²⁰Ne/²²Ne)_{standard}; obtaining a real value of the sample according to (²⁰Ne/²²Ne)_{sample real}=(²⁰Neₛₐₘₚₗₑ/²²Neₛₐₘₚₗₑ)/D.

### TECHNICAL FIELD

The disclosure relates to a field of isotope measurement, and in particular to a method for calibrating a mass discrimination effect of a neon isotope ratio.

### BACKGROUND

Neon (Ne) has three isotopes, ²⁰Ne, ²¹Ne and ²²Ne. Its relatively simple isotope fractionation process and easy-to-distinguish endmember characteristics make neon isotopes widely used to identify endmembers such as crust, mantle, planets, atmosphere, solar wind and cosmic rays. Therefore, a more accurate measurement method for neon isotopes needs to be developed. Sophie et al. developed a technique of measuring Ne isotopes, mainly aiming at the interference of ⁴⁰Ar²⁺ to ²⁰Ne⁺ in the static measurement of the noble gas mass spectrometer, and put forward relevant calibration and solutions. Györe et al. have developed a high-precision method for measuring ²¹Ne⁺, and put forward relevant calibration and solutions for the interference of ²⁰NeH⁺ in the static measurement of noble gas mass spectrometer. At present, there is a lack of a method to calibrate the mass discrimination effect caused by the measurement of the noble gas mass spectrometer itself.

### SUMMARY

In view of the shortcomings in the prior art mentioned above, the purpose of the present disclosure is to provide a method for calibrating a mass discrimination effect of a neon isotope ratio, to eliminate or minimize the influence caused by different mass discrimination effects during sample measurement through calibration experiments of standard gases.

In order to achieve the above and other related purposes, the disclosure provides a method for calibrating the neon isotope ratio mass discrimination effect, including the following steps:
S1, providing N kinds of standard gases with different gas semaphores, and respectively testing ²⁰Ne and ²²Ne in the N kinds of standard gases (air) by using a mass spectrometer to obtain N data sets, where N is an integer greater than 3;
S2, obtaining a functional equation shown in Formula (1) from the N data sets in the S1 by a mathematical fitting method;

(²⁰Ne/²²Ne)ₐᵢᵣ=²⁰Ne/²²Ne=A(²²Ne)+B (1),

where A and B are constants;
S3, providing a test sample, and testing ²⁰Neₛₐₘₚₗₑ and ²²Neₛₐₘₚₗₑ in the sample by a mass spectrometer;

S4, making ²²Ne in Formula (1) equal to ²²Neₛₐₘₚₗₑ, obtaining a functional equation shown in Formula (2):

$${( {}^{20} Ne / {}^{22} Ne )}_{air ( sample )} = A {(}^{22} {Ne}_{sample} ) + B ; \qquad ( 2 )$$

S5, obtaining a mass discrimination factor according to Formula (3):

D=(²⁰Ne/²²Ne)ₐᵢᵣ₍ₛₐₘₚₗₑ₎/(²⁰Ne/²²Ne)_{standard} (3),

where (²⁰Ne/²²Ne) standard represents an abundance ratio of ²⁰Ne and ²²Ne isotopes in the standard (air);
S6, obtaining a real value of the sample according to Formula (4);

$${( {}^{20} Ne / {}^{22} Ne )}_{sample real} = ( {}^{20} {Ne}_{sample} / {}^{22} {Ne}_{sample} ) / D . \qquad ( 4 )$$

In some embodiments of the disclosure, the method further includes following steps:
S7, calculating Root Mean Square Error (RMSE) of the function equation shown in Formula (1); and
S8, obtaining an error percentage according to Formula (5):

$${Error ( {}^{20} Ne / {}^{22} Ne )}_{sample real} ( \% ) = RMSE / {( {}^{20} Ne / {}^{22} Ne )}_{air ( sample )} * 100. \qquad ( 5 )$$

In some embodiments of the present disclosure, standard gases with the N kinds of different gas semaphores obtains a semaphore of 3000-200000 cps for ²²Ne; the semaphore of ²⁰Ne is 30000-2000000 cps (the measurement limit of an electron multiplier does not being capable of exceeded).

In some embodiments of the present disclosure, in the S1, ²⁰Ne represents a semaphore after background subtraction.

In some embodiments of the present disclosure, ²⁰Ne represents a semaphore after subtracting the background and calibrating ⁴⁰Ar²⁺; for distinction, ²⁰Ne after background subtraction and calibration as described above is denoted by ²⁰Ne* in specific embodiments of the present disclosure.

In some embodiments of the present disclosure, in the S1, ²²Ne represents a semaphore after background subtraction, and for distinction, ²²Ne after background subtraction as described above is represented by ²²Ne* in specific embodiments of the present disclosure.

In some embodiments of the present disclosure, ²⁰Neₛₐₘₚₗₑ represents a semaphore after background subtraction; ²²Neₛₐₘₚₗₑ represents a semaphore after background subtraction, and is still represented by ²²Neₛₐₘₚₗₑ.

In some embodiments of the present disclosure, ²⁰Neₛₐₘₚₗₑ represents a semaphore after subtracting the background and calibrating ⁴⁰Ar²⁺, and is still represented by ²⁰Neₛₐₘₚₗₑ.

In some embodiments of the present disclosure, the mathematical fitting method is a least square method.

In some embodiments of the present disclosure, an ion source of the mass spectrometer is a Nier type ion source.

In some embodiments of the present disclosure, the standard gas is air.

A second aspect of the present disclosure provides a computer-readable storage medium, the computer-readable storage medium is a non-transitory computer-readable storage medium, a computer program is stored on the computer-readable storage medium, and when a processor executes the program, the method for calibrating the mass discrimination effect of the neon isotope ratio is realized.

A third aspect of the present disclosure provides a terminal, including a processor and a memory, where the memory is used for storing a computer program, and the processor is used for executing the computer program stored in the memory, so that the terminal is capable of performing the method for calibrating the mass discrimination effect of the neon isotope ratio.

### BRIEF DESCRIPTION OF THE DRAWINGS

FIG. 1 shows a standard flow chart of a method for calibrating a mass discrimination effect of a neon isotope ratio according to an embodiment of the present disclosure.

FIG. 2 shows a functional equation of ²²Ne*−(²⁰Ne*/²²Ne*)ₐᵢᵣ according to the embodiment of the present disclosure.

FIG. 3 shows a schematic diagram of a terminal operating the method for calibrating the mass discrimination effect of the neon isotope ratio according to the embodiment of the present disclosure.

In the figures: 100, laser measuring terminal; 101, processor; 102, memory; 1021, operating system; 1022, application program; 103, network interface; 104, user interface; and 105, bus system.

### DETAILED DESCRIPTION OF THE EMBODIMENTS

Based on the goal of high-precision measurement of neon isotopes, the present disclosure found through exploration and research that rare gas mass spectrometers often adopt Nier type ion sources sensitive to gas pressure, which may cause a mass discrimination effect (the measured value may “deviate” from the real value due to the loss of light ions or heavy ions) when measuring Ne isotopes. This is particularly remarkable when measuring with electron multipliers, while most rock or mineral samples are measured with the electron multipliers. Suppose there is a significant difference between the standard gas (usually air) and the gas pressure of the neon isotope measured in the sample. In that case, the mass discrimination effect will significantly affect the calibration of the real value of the ²⁰Ne/²²Ne ratio of the sample, and further have an impact on the determination and discrimination of the end member characteristics of the sample. In measuring a series of unknown samples (rocks, minerals, etc.), it is expected to find that the neon gas pressure differs from one sample to another. If a unified standard gas pressure is used, the final calibration result will cause the sample measurement result to deviate from the real value if the sample and standard gases do not match, because it is impossible to predict the gas pressure of the sample to be measured, the disclosure aims to propose a method for calibrating a mass discrimination effect of a neon isotope ratio, so that the influence caused by different mass discrimination effects during sample measurement can be eliminated and reduced as much as possible through the calibration experiment of standard gas (air). On this basis, the present disclosure has been completed.

A method for calibrating a mass discrimination effect of a neon isotope ratio is provided in the first aspect of the disclosure, including the following steps:
S1, providing N kinds of standard gases with different gas semaphores, and respectively testing ²⁰Ne and ²²Ne in the N kinds of standard gases (air) by using a mass spectrometer to obtain N data sets, where N is an integer greater than 3;
where neon of standard gases with different gas pressures (semaphore) is achieved through the control of the purification system. Prior to measuring neon with the rare gas mass spectrometer, it is often necessary to purify and separate neon, which is carried out on the rare gas purification system (this process is the prior art, see for example the method for determining rare gases by laser melting of trace meteorites). Specifically, the purification system is usually controlled by multi-stage pneumatic valves or manual valves, and the gas pressure of standard gas and the volume between valves in the purification system are known, allowing the amount of neon gas to be controlled by valves. The purification system is equipped with molecular pumps and ion pumps, and the neon gas can be further diluted by pumping and valve interaction.

In an optional embodiment, neon isotopes (²⁰Ne, ²¹Ne and ²²Ne) are measured for neon gas with different gas pressures by an electron multiplier of the mass spectrometer, and the semaphore of each isotope is expressed as Counts Per Second (CPS) in the measurement results by the mass spectrometer. In order to improve the test accuracy, all the isotopes of neon are subtracted from the background. The background is the neon isotope measured by the electron multiplier of the mass spectrometer without the standard gas (air). Although the mass spectrometer is in an ultra-high vacuum below 10⁻⁷ Pa, it is not an absolute vacuum, so there is a leakage rate. The leakage rate refers to the gas amount that flows through the leak at a given temperature in a unit of time when the pressure difference between the two sides of the leak is known. Especially, after background subtraction of ²⁰Ne isotope, ⁴⁰Ar²⁺ should be calibrated by the method disclosed in CN107037112 B, and the result is expressed as ²⁰Ne*. In this embodiment, ²²Ne* represents the result of subtracting the background from the measurement result of ²²Ne. Subsequently, the calibrated measurement value of (²⁰Ne*/²²Ne*)ₐᵢᵣ=²⁰Ne*/²²Ne* of (²⁰Ne*/²²Ne*)ₐᵢᵣ ratio of neon gas with different gas semaphores is calculated. For the above results, it is possible to ensure that there are more than 10 data points, and n is optionally 10 or greater.

In an optional embodiment, the standard gases (air) with N kinds of different gas semaphores obtain a semaphore of 3000-200000 Cps for ²⁰Ne and 30000-2000000 cps for ²²Ne, that is, under the static measurement condition, the Cps count of an isotope is capable of being equivalent to the pressure level of an isotope in the mass spectrometer. The N kinds of different standard gases make the semaphore of each ²⁰Ne differ by at least one order of magnitude, and make the semaphore of each ²²Ne differ by at least one order of magnitude.

S2, obtaining a functional equation shown in Formula (1) from the N data sets in the S1 by a mathematical fitting method;

(²⁰Ne/²²Ne)ₐᵢᵣ=²⁰Ne/²²Ne=A(²²Ne)+B (1),

where A and B are constants, and are related to the fitting data.

After background subtraction of ²⁰Ne isotope, ⁴⁰Ar²⁺ should be calibrated by the method disclosed in CN107037112 B, and then ²⁰Ne is expressed as ²⁰Ne*, and ²²Ne is expressed by ²²Ne* after background subtraction. Specifically: ²²Ne* corresponding to neon with different gas semaphores are taken as the x axis and the (²⁰Ne*/²²Ne*) air ratio corresponding to neon with different gas semaphores are taken as the y axis for plotting. The drawing software is Datagraph. The ²²Ne* corresponding to neon with different gas semaphores are fit with the (²⁰Ne*/²²Ne*)ₐᵢᵣ ratio corresponding to neon with different gas semaphores by mathematical method linear least square method, and by minimizing the square of the error, the best function matching of the data is found and the function fitting is carried out, thus obtaining the linear expression of (²⁰Ne*/²²Ne*)ₐᵢᵣ ratio about ²²Ne* semaphores, (²⁰Ne*/²²Ne*)ₐᵢᵣ=A(²²Ne*)+B.

S3, providing a test sample, and testing ²⁰Neₛₐₘₚₗₑ and ²²Neₛₐₘₚₗₑ in the sample by a mass spectrometer.

Specifically, after obtaining the linear expression and the root mean square error of (²⁰Ne*/²²Ne*)ₐᵢᵣ ratio with respect to ²²Ne* semaphore, for the ²⁰Ne isotope obtained by sample measurement, a ²⁰Neₛₐₘₚₗₑ is obtained by performing the method disclosed in CN107037112 B and subtracting the background, and (²⁰Ne/²²Ne)ₛₐₘₚₗₑ is obtained by comparing ²⁰Neₛₐₘₚₗₑ with the ²²Neₛₐₘₚₗₑ isotope of the sample (after background subtraction).

S4, making ²²Ne* in Formula (1) equal to ²²Neₛₐₘₚₗₑ, obtaining a functional equation shown in Formula (2):

$${( {}^{20} Ne / {}^{22} Ne )}_{air ( sample )} = A {(}^{22} {Ne}_{sample} ) + B . \qquad ( 2 )$$

Specifically, the ²²Neₛₐₘₚₗₑ value of the sample is substituted into ²²Ne* in the fit linear function relation of the standard gases obtained in S2: (²⁰Ne*/²²Ne*)ₐᵢᵣ=A(²²Ne*)+B, the theoretically predicted and instrument-calibrated (²⁰Ne/²²Ne)ₐᵢᵣ₍ₛₐₘₚₗₑ₎ ratio corresponding to standard gas (air) is obtained when the semaphore is the same as that of (²²Ne)ₛₐₘₚₗₑ.

S5, obtaining the mass discrimination factor according to Formula (3):

D=(²⁰Ne/²²Ne)ₐᵢᵣ₍ₛₐₘₚₗₑ₎/(²⁰Ne/²²Ne)_{standard} (3),

where (²⁰Ne/²²Ne)_{standard} represents an abundance ratio of ²⁰Ne and ²²Ne isotopes in the standard (air).

Specifically, by comparing abundances of ²⁰Ne and ²²Ne isotopes (standard values) in gas (air) published by the International Union of Pure and Applied Chemistry, the true air standard value (²⁰Ne/²²Ne)_{standard} is 9.78.

S6, obtaining a real value of the sample according to Formula (4);

$${( {}^{20} Ne / {}^{22} Ne )}_{sample real} = ( {}^{20} {Ne}_{sample} / {}^{22} {Ne}_{sample} ) / D . \qquad ( 4 )$$

S7, calculating Root Mean Square Error (RMSE) of the function equation shown in Formula (1), RMSE is the standard deviation of the residual error (prediction error).

S8, obtaining an error percentage according to Formula (5):

$${Error ( {}^{20} Ne / {}^{22} Ne )}_{sample real} ( \% ) = RMSE / {( {}^{20} Ne / {}^{22} Ne )}_{air ( sample )} * 100. \qquad ( 5 )$$

According to the method for calibrating the mass discrimination effect of the neon isotope ratio provided by the disclosure, based on the parameters of the existing instruments and mass spectrometers, by measuring standard gases with different gas semaphores, and by analytical and mathematical methods, the influence caused by different mass discrimination effects during measurement due to different gas semaphores of samples and standard gases is eliminated and reduced, and the errors introduced by the mass discrimination effect is considered, thus ensuring the reliability of the sample result (²⁰Ne/²²Ne)_{sample real}.

In the present disclosure, ²⁰Ne* represents the result after background subtraction and then after ⁴⁰Ar²⁺ calibration of the standard gases (air) with different gas semaphores; (²⁰Ne*/²²Ne*)ₐᵢᵣ represents the ratio of the measured calibration values ²⁰Ne* and ²²Ne* of the standard gases (air) with different gas semaphores; the fitting function refers to (²⁰Ne*/²²Ne*)ₐᵢᵣ=A(²²Ne*)+B, and the root mean square error refers to the fitting RMSE value; ²⁰Neₛₐₘₚₗₑ and ²²Neₛₐₘₚₗₑ represent the results after background subtraction and then after ⁴⁰Ar²⁺ calibration of the samples; (²⁰Ne/²²Ne) sample represents the ratio of the measured calibration values (²⁰Neₛₐₘₚₗₑ and ²²Neₛₐₘₚₗₑ) of the samples; (²⁰Ne/²²Ne)ₐᵢᵣ₍ₛₐₘₚₗₑ₎ represents a theoretical predicted value after instrument measurement and calibration of the standard gas (air) corresponding to the gas semaphore of the sample obtained from (²⁰Ne*/²²Ne*)ₐᵢᵣ=A(²²Ne*)+B; D represents a mass discrimination factor; (²⁰Ne/²²Ne)_{sample real} represents the real value of the sample after the mass discrimination effect is calibrated. In this disclosure, the semaphores mentioned in the standard gases (air) with different semaphores represent the semaphores obtained by the electron multiplier in the experiment, and the standard gases (air) with different semaphores correspond to the standard gases (air) with different pressures.

A second aspect of the present disclosure provides a computer-readable storage medium, a computer program is stored on the computer-readable storage medium, and when the program is executed by a processor, the method for calibrating the mass discrimination effect of the neon isotope ratio provided in the first aspect of the present disclosure is realized.

A third aspect of the disclosure provides a terminal, including a processor and a memory, where the memory is used for storing a computer program, and the processor is used for executing the computer program stored in the memory, so that the terminal is capable of performing the method for calibrating the mass discrimination effect of the neon isotope ratio provided in the first aspect of the disclosure.

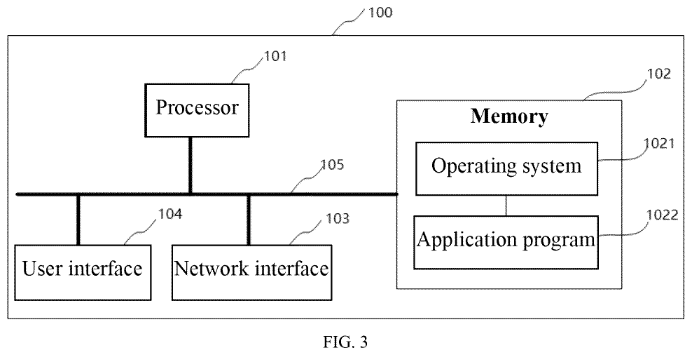

Regarding the terminal hardware structure of the method for calibrating the mass discrimination effect of the neon isotope ratio, an alternative hardware structure diagram of a laser measuring terminal 100 is shown in FIG. 3, the laser measuring terminal 100 is capable of being a mobile phone, a computer device, a tablet device, a personal digital processing device, a factory background processing device and the like. The laser measuring terminal 100 includes at least one processor 101, a memory 102, at least one network interface 103 and a user interface 104. The components in the device are coupled together by a bus system 105. It may be understood that the bus system 105 is used to realize connection communication between these components. The bus system 105 includes a power bus, a control bus and a status signal bus in addition to a data bus.

The user interface 104 may include a display, a keyboard, a mouse, a trackball, a pointing gun, keys, buttons, a touch panel or a touch screen. It is understood that the memory 102 may be a volatile memory or a nonvolatile memory, and may also include both volatile and nonvolatile memories. And the nonvolatile memory may be a Read Only Memory (ROM) or a Programmable Read-Only Memory (PROM), and is used as an external cache. By way of illustration but not limitation, many forms of Random Access Memory (RAM) are available, such as StaticRandom Access Memory (SRAM) and Synchronous Static RandomAccess Memory (SSRAM). The memories described in the embodiment of the present disclosure are intended to include, but are not limited to, these and any other suitable types of memories.

The memory 102 in the embodiment of the present disclosure is used to store various kinds of data to support the operation of the laser measuring terminal 100. Examples of these data include: any executable program for operating on the laser measuring terminal 100, such as an operating system 1021 and an application program 1022; the operating system 1021 includes various system programs, such as framework layer, core library layer, driver layer, etc., for implementing various basic services and handle hardware-based tasks. The application program 1022 may include various applications, such as a MediaPlayer, a Browser, etc., for implementing various application services. A laser measurement method for endoscopic detection of tumor size provided by the embodiment of the present disclosure may be included in the application program 1022.

The method disclosed in the above embodiment of the present disclosure may be applied to or realized by the processor 101. The processor 101 may be an integrated circuit chip with signal processing capability. In the process of implementation, each step of the above method is capable of being completed by an integrated logic circuit of hardware or instructions in the form of software in the processor 101. The processor 101 may be a general processor, a Digital Signal Processor (DSP), or other programmable logic devices, discrete gate or transistor logic devices, discrete hardware components, and the like. The processor 101 may implement or execute the methods, steps and logic blocks disclosed in the embodiments of the present disclosure. The processor 101 in common use may be a microprocessor or any conventional processor or the like. Combined with the steps of the accessory optimization method provided by the embodiment of the disclosure, it may be directly embodied as the completion of the hardware decoding processor or the completion of the combination of hardware and software modules in the decoding processor. The software module may be located in a storage medium, the storage medium is located in the memory, and the processor reads the information in the memory and completes the steps of the aforementioned method in combination with its hardwares.

In an exemplary embodiment, the laser measuring terminal 100 may be used by one or more Application Specific Integrated Circuits (ASIC), DSP, Programmable Logic Device (PLD) and Complex Programmable LogicDevice (CPLD) to perform the aforementioned methods.

The specific embodiment of the present disclosure is described below, and those skilled in the art can easily understand other advantages and effects of the present disclosure from the contents disclosed in this specification. The disclosure is also capable of being implemented or applied by other different specific embodiments, and various details in this specification is capable of being modified or changed based on different viewpoints and applications without departing from the spirit of the disclosure.

### Embodiment 1

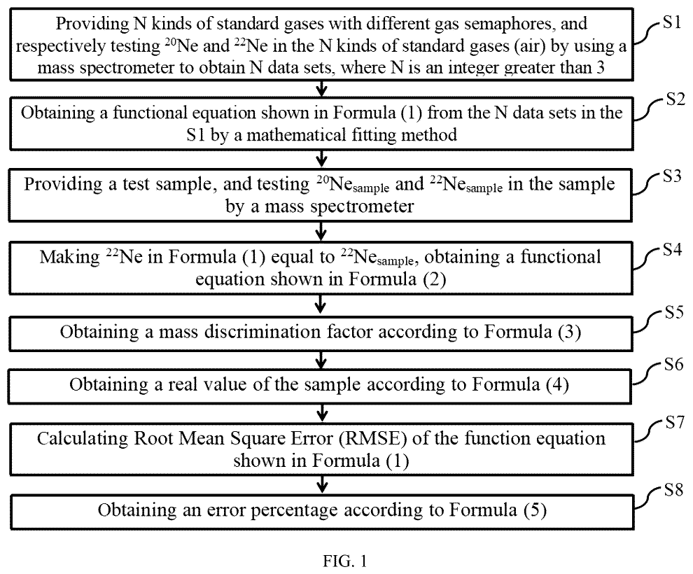

S1, obtaining N=20 (see in FIG. 1) groups of neon of standard gases (air) with different gas semaphores with the cooperation of valves, molecular pumps and ion pumps; calibrating ⁴⁰Ar²⁺ by the method disclosed in CN107037112 B after mass spectrometer measurement, background subtraction and background subtraction of ²⁰Ne isotope, and obtaining ²²Ne* with different semaphores and the (²⁰Ne*/²²Ne*)ₐᵢᵣ ratio corresponding to the semaphores, the data results are shown in Table 1:

TABLE 1

| No. | 1 | 2 | 3 | 4 | 5 |
|---|---|---|---|---|---|
| ²²Ne* | 2.10E+05 | 2.09E+05 | 1.09E+05 | 9.87E+03 | 4.39E+04 |
| ²⁰Ne*/²²Ne* | 8.87 | 8.90 | 9.26 | 9.67 | 9.46 |
| No. | 6 | 7 | 8 | 9 | 10 |
| ²²Ne* | 4.90E+03 | 9.97E+03 | 3.68E+03 | 3.12E+03 | 1.87E+03 |
| ²⁰Ne*/²²Ne* | 9.66 | 9.63 | 9.67 | 9.63 | 9.77 |
| No. | 11 | 12 | 13 | 14 | 15 |
| ²²Ne* | 6.07E+03 | 8.64E+04 | 2.05E+05 | 1.68E+05 | 4.39E+04 |
| ²⁰Ne*/²²Ne* | 9.67 | 9.36 | 8.94 | 9.08 | 9.52 |
| No. | 16 | 17 | 18 | 19 | 20 |
| ²²Ne* | 4.24E+04 | 2.01E+05 | 1.99E+05 | 1.98E+05 | 1.98E+05 |
| ²⁰Ne*/²²Ne* | 9.53 | 8.95 | 8.94 | 8.97 | 8.98 |

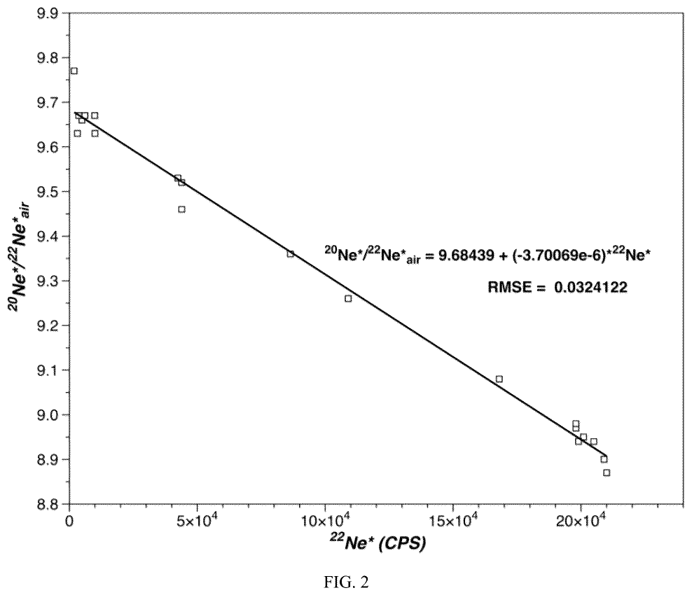

S2, taking ²²Ne* corresponding to neon with 20 groups of different gas semaphores in the S1 as the X axis and the corresponding (²⁰Ne*/²²Ne*)ₐᵢᵣ ratios as the Y axis for plotting, where the plotting software adopts Datagraph, and the plotting result is shown in FIG. 2.

The linear least squares method is used to fit the ²²Ne* corresponding to neon with different gas semaphores and the corresponding (²⁰Ne*/²²Ne*)ₐᵢᵣ ratios, thus the linear expression of (²⁰Ne*/²²Ne*)ₐᵢᵣ ratio about ²²Ne semaphore is obtained, (²⁰Ne*/²²Ne*)ₐᵢᵣ=−3.70069e⁻⁶(²²Ne*)+9.68439, and the fitting root mean square error RMSE=0.0324122 is calculated.

S3, for example, obtaining the ²⁰Neₛₐₘₚₗₑ and ²²Neₛₐₘₚₗₑ results after subtracting the background from the measured value of Sample 18 and calibrating ⁴⁰Ar²⁺ by the method described in CN107037112 B on ²⁰Ne. Sample 18: ²⁰Neₛₐₘₚₗₑ=1.77E^{+05 22}Neₛₐₘₚₗₑ=1.41E+04, and the measured calibration value of Sample 18 is (²⁰Ne/²²Ne)ₛₐₘₚₗₑ=12.55, and ²²Neₛₐₘₚₗₑ=1.41E⁺⁰⁴ is substituted into (²⁰Ne*/²²Ne*)ₐᵢᵣ=−3.70069e⁻⁶(²²Ne*)+9.68439, and (²⁰Ne/²²Ne)ₐᵢᵣ₍ₛₐₘₚₗₑ₎=9.63 is obtained.

S4, comparing the theoretical predicted value (²⁰Ne/²²Ne)ₐᵢᵣ₍ₛₐₘₚₗₑ₎=9.63 of standard gas (air) corresponding to the ²²Neₛₐₘₚₗₑ gas amount (1.41E⁺⁰⁴) of Sample 18 obtained in the S3 with the ratio (9.78) of (²⁰Ne/²²Ne) standard in the standard air published by the International Union of Pure and Applied Chemistry, and obtaining a mass discrimination calibration factor D of Sample 18:

$$D = {( {}^{20} Ne / {}^{22} Ne )}_{air ( sample )} / {( {}^{20} Ne / {}^{22} Ne )}_{standard} = 9.63 / 9.78 = 0.985 .$$

S5, comparing the measured calibration value (²⁰Ne/²²Ne)ₛₐₘₚₗₑ=12.55 of Sample 18 obtained in the S3 with the mass discrimination calibration factor D of Sample 18 obtained in the S4, obtaining the real value of Sample 18 after the mass discrimination effect calibration of Sample 18:

$${( {}^{20} Ne / {}^{22} Ne )}_{sample real} = ( {}^{20} Ne / {}^{22} Ne ) sample / D = 12.55 / 0.985 = 1274.$$

Accordingly, according to the real value of Sample 18 and the fitting root mean square error RMSE calculated in the S2, the error percentage of the real value of Sample 18 is calculated as follows:

$${Error ( {}^{20} Ne / {}^{22} Ne )}_{sample real} ( \% ) = RMSE / {( {}^{20} Ne / {}^{22} Ne )}_{air ( sample )} = 0.0324122 / 9.63 * 100 = 0.34 \% ;$$

the final real value of Sample 18 (²⁰Ne/²²Ne)_{sample real} may be expressed as 12.74±0.04.

If the mass discrimination effect is calibrated in a conventional way that the semaphore of the sample and the standard gas does not match, taking the semaphore of standard gas (air) ²²Ne*=2.0e⁺⁵ as an example, (²⁰Ne*/²²Ne*)ₐᵢᵣ=8.94, and the final (²⁰Ne/²²Ne)_{sample real} value of Sample 18 is 13.73, so this conventional calibration method ignores the mass discrimination effect caused by different semaphores, thus making the calibration result of the sample deviate from the real value by about 10%.

It is worth noting that the calibration experiment of standard gas is the first time in this application to eliminate and reduce the influence of different mass discrimination effects in sample measurement as much as possible. The purpose of calibrating ⁴⁰Ar²⁺ by using the method disclosed in CN107037112 B is to make the test results more accurate.

To sum up, the disclosure eliminates or reduces as much as possible the influence caused by different mass discrimination effects during sample measurement through the calibration experiments of the standard gases.

The above-mentioned embodiment only illustrates the principle and efficacy of the present disclosure, and is not used to limit the present disclosure. Anyone familiar with this technology is capable of modifying or changing the above embodiments without violating the spirit and scope of the present disclosure. Therefore, all equivalent modifications or changes made by people with ordinary knowledge in the technical field without departing from the spirit and technical ideas disclosed in the present disclosure should still be covered by the claims of the present disclosure.

1. A method for calibrating a mass discrimination effect of a neon isotope ratio, comprising following steps:
S1, providing N kinds of standard gases with different gas semaphores, and respectively testing ²⁰Ne and ²²Ne in the N kinds of standard gases by using a mass spectrometer to obtain N data sets, wherein N is an integer greater than 3,
wherein semaphores in the standard gases with different semaphores represent semaphores obtained by an electron multiplier in experiments, and the standard gases with different semaphores correspond to standard gases with different pressures;
S2, obtaining, by one or more processors, a functional equation shown in Formula (1) from the N data sets in the S1 by a mathematical fitting method; wherein the mathematical fitting method is a least square method:
(²⁰Ne/²²Ne)ₐᵢᵣ=²⁰Ne/²²Ne=A(²²Ne)+B (1),
wherein A and B are constants;
(²⁰Ne/²²Ne) air represents a ratio of ²⁰Ne to ²²Ne;
S3, providing a test sample, and testing ²⁰Neₛₐₘₚₗₑ and ²²Neₛₐₘₚₗₑ in the sample by the mass spectrometer;
S4, making ²²Ne in Formula (1) equal to ²²Neₛₐₘₚₗₑ by the one or more processors, obtaining, by the one or more processors, a functional equation shown in Formula (2):
$${( {}^{20} Ne / {}^{22} Ne )}_{air ( sample )} = A {(}^{22} {Ne}_{sample} ) + B ; \qquad ( 2 )$$
S5, obtaining, by the one or more processors, a mass discrimination factor according to Formula (3):
D=(²⁰Ne/²²Ne)ₐᵢᵣ₍ₛₐₘₚₗₑ₎/(²⁰Ne/²²Ne)_{standard} (3),
wherein (²⁰Ne/²²Ne)_{standard} represents an abundance ratio of ²⁰Ne and ²²Ne isotopes in the standard gases, and (²⁰Ne/²²Ne)ₐᵢᵣ₍ₛₐₘₚₗₑ₎ is obtained from S4;
S6, obtaining, by the one or more processors, a real value of the sample according to Formula (4);
$${( {}^{20} Ne / {}^{22} Ne )}_{sample real} = ( {}^{20} {Ne}_{sample} / {}^{22} {Ne}_{sample} ) / D \qquad ( 4 )$$
further comprising: outputting, by the one or more processors, the real value of the sample to a display to display the real value of the sample, which represents completion of calibrating the mass discrimination effect of the neon isotope ratio caused by the mass spectrometer itself.

2. The method for calibrating the mass discrimination effect of the neon isotope ratio according to claim 1, further comprising following steps:
S7, calculating, by the one or more processors, Root Mean Square Error (RMSE) of the function equation shown in Formula (1); and
S8, obtaining, by the one or more processors, an error percentage according to Formula (5):
$${Error ( {}^{20} Ne / {}^{22} Ne )}_{sample real} ( \% ) = RMSE / {( {}^{20} Ne / {}^{22} Ne )}_{air ( sample )} * 100. \qquad ( 5 )$$

3. The method for calibrating the mass discrimination effect of the neon isotope ratio according to claim 1, wherein standard gases with the N kinds of different gas semaphores obtains a semaphore of 3000-200000 cps for ²²Ne; the semaphore of ²⁰Ne is 30000-2000000 cps.

4. The method for calibrating the mass discrimination effect of the neon isotope ratio according to claim 1, wherein in the S1, ²⁰Ne represents a semaphore after background subtraction; ²²Ne represents a semaphore after background subtraction.

5. The method for calibrating the mass discrimination effect of the neon isotope ratio according to claim 4, wherein ²⁰Ne is the semaphore after subtracting the background and calibrating ⁴⁰Ar²⁺.

6. The method for calibrating the mass discrimination effect of the neon isotope ratio according to claim 1, wherein ²⁰Neₛₐₘₚₗₑ represents a semaphore after background subtraction;
²²Neₛₐₘₚₗₑ represents a semaphore after background subtraction.

7. The method for calibrating the mass discrimination effect of the neon isotope ratio according to claim 6, wherein ²⁰Neₛₐₘₚₗₑ represents a semaphore after subtracting the background and calibrating ⁴⁰Ar²⁺.

8. The method for calibrating the mass discrimination effect of the neon isotope ratio according to claim 1, further comprising at least one of following technical features:
an ion source of the mass spectrometer is Nier type ion source; and
the standard gas is air.

9-10. (canceled)

11. The method for calibrating the mass discrimination effect of the neon isotope ratio according to claim 2, further comprising:
obtaining, by the one or more processors, a real value range of the sample according to the real value obtained in S6 and the error percentage obtained in S8, and outputting, by the one or more processors, the real value range of the sample to the display to display the real value range of the sample.
